(19) United States
(12) Patent Application Publication
(10) Pub. No.: US 2006/0112143 A1
(43) Pub. Date: May 25, 2006

(54) Method and system to facilitate publishing and distribution of digital media

(75) Inventor: Kumar Subramanian, Dublin, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: MediaMellon, Inc.

(21) Appl. No.: 11/257,532

(22) Filed: Oct. 25, 2005

Related U.S. Application Data
(60) Provisional application No. 60/621,918, filed on Oct. 25, 2004.

(51) Int. Cl. G06F 17/00

(52) U.S. Cl. 707/104.1

(57) ABSTRACT

A method and system to facilitate publishing and distribution of digital media are disclosed. In one embodiment, the method comprises receiving parameters describing a category of media files. One or more media files are identified that correspond to the category of media files. The one or more media files are identified as the one or more media files become available. The one or more media files are pushed to a device node according to connectivity parameters.

The present application claims the benefit of and priority to U.S. Provisional Patent Application No. 60/621,918 entitled “Method and System to Facilitate Publishing and Distribution of Digital Media,” and filed on Oct. 25, 2004, and is hereby, incorporated by reference.

### FIELD OF THE INVENTION

The field of the invention relates generally to networked computer systems and more particularly relates to a method and system to facilitate publishing and distribution of digital media.

### BACKGROUND

Traditionally, recorded media have been distributed in the form of tapes, CDs, etc over various channels, including theatrical releases; retailers, such as Blockbuster or Netflix; sell-throughs, from Walmart or BestBuy; cable Video-on-Demand or cable Pay-per-view, and direct mailing.

Over the past few years, there has been increased interest in delivering such media over the Internet. This has been driven by developments including transition from analog to digital media formats; ease of creating digital media by ordinary people, falling costs of digital camcorders, movie phones, and other such consumer electronic devices; availability of a variety of devices to view or ‘consume’ such media, such as Home Theatres, Microsoft's Media Center PCs, Apple's iPOD, gaming consoles, etc.; steep decline in the cost of storage; and increasing broadband penetration.

However, the ability to publish and distribute such media over a network remains relatively difficult. In order to distribute a media file, it is typically hosted and served out of a server, and connected to a network, such as the Internet. As the size of the media files increase, as is the case with movies, games, etc, it usually becomes ineffective to serve media using a personal server. Then, the options available to the content owner, include using a media server, that could be co-located in a datacenter—which is expensive; and/or using a Content Delivery Network, such as those operated by companies such as Akamai, Speedera, Limelight Networks, etc. Again, this is an expensive option. It typically costs about 60 cents to transfer a GB of data even with volume discounts. The CDN operators also have minimum volume commitments and set-up charges.

Another challenge in the distribution of digital media, relates to the process by which media owners find potential audiences, and media consumers learn about interesting media. In the case of Hollywood movie content, the media owners usually spend enormous amounts of money to advertise their content, so as to heighten awareness among potential consumers. There are several instances where such advertisements may not effective, or may not be affordable, such as:

(a) independent movie producers who may not be able to afford Hollywood's advertising budget and distribution power

(b) special interest movies, such as ethnic movies, that have a narrow audience

(c) non-commercial media, such as a video recording of an alumni reunion that may be of interest to thinly dispersed audience.

In addition to media distributors' challenge in finding consumers, consumers interested in such content find it difficult or inconvenient to be able to get their hands on such media.

Yet another challenge relates to the lack of reliability and the intermittent connectivity of devices to the Internet. If the source of a media file is not connected to the network at the time that a media file is requested by another device, then the media file will not be available to the requesting device or user. This is particularly important in the case of mobile devices. An added challenge with mobile devices is that they may access the Internet over different kinds of access networks, as the user of the devices moves around—for instance, across different cellular networks, and Wi-Fi networks. As that happens, the device's IP address keeps changing and it becomes difficult for another device to locate it.

Yet another challenge relates to devices, typically mobile devices that have multiple modes of accessing a network. For example, there are PDAs that can connect via Wi-Fi, or cellular. In time, there will be more modes of connectivity that will appear such as WiMax. Different connectivity modes have different capacities, and different costs to the user. When the user requests a given recorded media file, he may not necessarily be in a location where he has the preferred connectivity options.

### SUMMARY

A method and system to facilitate publishing and distribution of digital media are disclosed. In one embodiment, the method comprises receiving parameters describing a category of media files. One or more media files are identified that correspond to the category of media files. The one or more media files are identified as the one or more media files become available. The one or more media files are pushed to a device node according to connectivity parameters.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a block diagram of an exemplary system for the publication and distribution of digital media, according to one embodiment of the present invention;

FIG. 2 illustrates an exemplary computer architecture for use with the present system, according to one embodiment of the invention;

FIG. 3 illustrates a block diagram of an exemplary media distribution and publishing framework within a system, according to one embodiment of the present invention;

FIG. 4 illustrates a block diagram of a multimodal environment, according to one embodiment of the present invention;

FIG. 5 illustrates a flow diagram of an exemplary network node assignment process, according to one embodiment of the present invention;

FIG. 6 illustrates a block diagram of the processes performed by the different layers of framework, according to one embodiment of the present invention;

FIG. 7 illustrates a flow diagram of an exemplary process for moving media file components into a node, according to one embodiment of the present invention; and

FIG. 8 illustrates a flow diagram of an exemplary process for publishing a media file, according to one embodiment of the present invention.

### DETAILED DESCRIPTION

A method and system to facilitate publishing and distribution of digital media are disclosed. In one embodiment, the method comprises receiving parameters describing a category of media files. One or more media files are identified that correspond to the category of media files. The one or more media files are identified as the one or more media files become available. The one or more media files are pushed to a device node according to certain parameters including connectivity parameters.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of wireless networks and computer systems. These wireless network descriptions and representations are the means used by those skilled in the wireless networking arts to most effectively convey the substance of their work to others skilled in the art. A wireless network is here, and generally, conceived to be a system for communications among two or more computers using radio waves as its carrier. Usually, though not necessarily, the information communicated between computer systems takes the form of packets. Furthermore, for reasons of common usage, the components of the packets are referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “router” or “radio” or “frequency” or “channel” or “backbone” or “packet” or “communicate” or the like, refer to the components, and actions and processes of a network, or similar communication system, that transfers data represented as physical (electronic) quantities within the computer system's registers and memories or other such information storage, transmission or display device from one computer system to another.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

According to one embodiment, the following list describes definitions for terms used herein:

media or digital media: items such as movies, software, games, e-books, etc.

media file, or object: data or blocks of data comprising media, such as movies, software, games, e-books, etc.

device node: a device that is, or can be, connected to a common network, such as the Internet. Device nodes could be fixed or mobile, and examples are PCs, PVRs, videophones, etc. Such devices can act as the source or the destination of media files.

network node, or a network node: a node in the network that facilitates the transfer or distribution of media files among device nodes. Network nodes may or may not be dedicated nodes for the purpose of facilitating such transfer or distribution. Optionally, device nodes themselves can act as network nodes.

system: a distributed system including device nodes, and network nodes.

directory or index: databases that are maintained in the system that may reside either in a single node, or be shared/distributed across different nodes.

The present method and system may allow for one or more of the following:
(a) distribution of media over a network between devices connected to that network
(b) pre-populating the network with a media before it is released for consumption
(c) transfer of media files and media components from a node(s) to other node(s) facilitated by a third party
(d) media distributors to publish based on metadata associated with that media file, and optionally impose any restrictions or require permissions related to consumption of that media file
(e) media consumers to be able to subscribe to media files on the basis of metadata
(f) distribution of media in a way that is efficient with respect to the storage, bandwidth and connectivity options available to the various devices involved in the distribution.
   i. Distributing media in a way that scales with the size of the audience.
   ii. Sharing and referring media among consumers and communities, that could allow easier discovery and/or greater consumption of such media.
   iii. Allowing media owners and distributors to identify their audience via subscriptions, and for consumers of media to identify interesting content.
   iv. Restricting access to media for consumers based on rights.

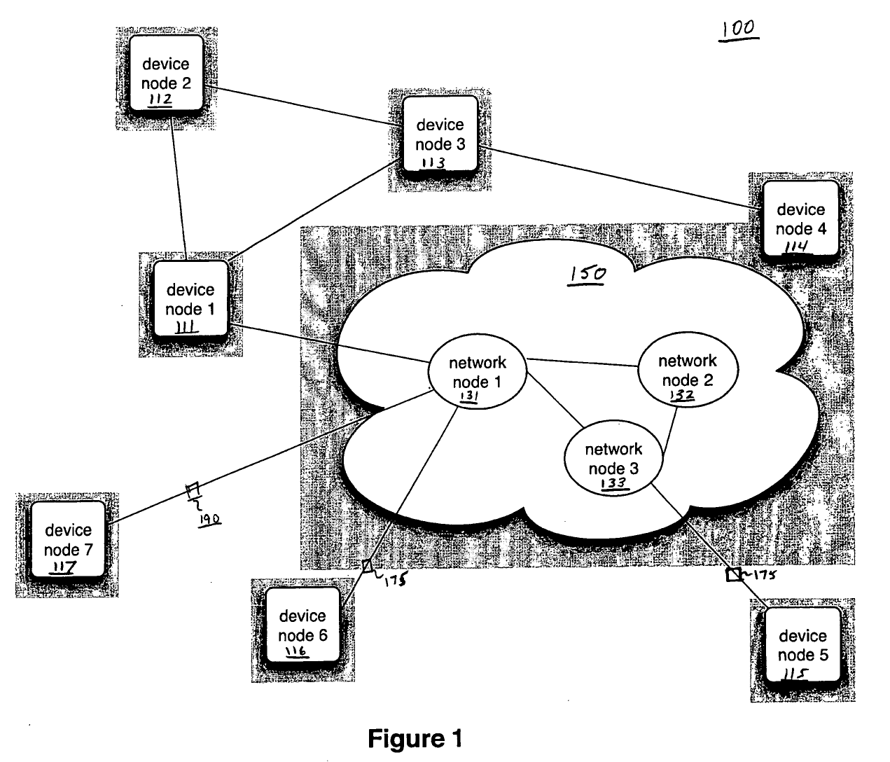

FIG. 1 illustrates a block diagram of an exemplary system for the publication and distribution of digital media, according to one embodiment of the present invention. System 100 includes device nodes 111-117 and network nodes 131-133. The processes executed within system 100 may be implemented in software or hardware. a device that is, or can be, connected to a common network, such as the Internet. Device nodes 111-117 could be fixed devices such as set top boxes, desk top computers, media recorders such as those manufactured by TiVo, Inc. of Alviso, Calif., game devices such as the XBox manufactured by Microsoft, Corp. of Redmond, Wash. or similar devices. Device nodes 111-117 may also be mobile devices, such as videophones, laptops, smart phones, mobile phones, PDAs, game devices such as the PSP manufactured by Sony Electronics, multimedia devices such as iPods manufactured by Apple Computers of Cupertino, Calif., or similar devices.

Any of device nodes 111-117 may be a multi-modal device—that is a device that has multiple physical methods to connect to network 150. For example, a cell phone with both cellular and Wi-Fi connectivity, or a PDA with cellular, WiMax and Wi-Fi connectivity would be examples of multi-modal devices. Device nodes 111-117 can act as the source or the destination of media files 175 that may blocks of data comprising media, such as movies, software, games, or e-books, according to one embodiment of the present invention. One or more of device nodes 111-117 may allow network access via a web browser such as Microsoft's Internet Explorer, Netscape Browser or the Safari Browser that support HTML.

Network nodes 131-133 are nodes in system 100 that facilitate the transfer or distribution of media files 175 among device nodes 111-117. Network nodes 131-133 may or may not be dedicated nodes for the purpose of facilitating such transfer or distribution. In one embodiment, device nodes 111-117 act as network nodes 131-133. Network nodes 131-133 may be web servers that use any one of a number of well-known protocols and/or applications including HyperText Transfer Protocol (HTTP), File Transfer Protocol (FTP), Internet Relay Chat (IRC), etc., via a TCP/IP connection (not shown in this view) or some other connection well known in the art. The operating system may be Windows®, LINUX, SUN Solaris®, Mac OS or other similar operating system. In one embodiment, Network nodes 131-133 may be dedicated servers, that use processing logic, tools and databases, that could be built using a combination of technologies such as those from Apache Software (www.apache.org) such as Tomcat servers; Java based technologies such as J2EE, EJB, JBOSS, JDBC; and/or databases such as MySQL.

Network 150 interconnects device nodes 111-117 and network nodes 131-133. According to one embodiment, network 150 is described as being the Internet, alternatively, the network 150 may be a Wide Area Network (WAN), a Local Area Network (LAN), or any other system of interconnections enabling two or more devices to exchange information. Further, the network 150 may include a wireless network, such that one or more of device nodes 111-117 may be wireless devices. System 100 may be a peer-to-peer network, as well. System 100 may also include other supporting computing software and hardware, for example, databases, computers, and user interface servers.

Before describing elements of system 100 in depth, an example is provided to help explain the capabilities of the present method and system. In one embodiment a user uses his device (for example, a laptop with web browser, such as device node 111 to describe attributes of a media that he is interested in. For example, using device node 111, the user indicates his interest in subscribing to media, that are (i) movies, (ii) recommended by Discovery Channel and (iii) about African wildlife and (iii) produced in the last 3 years. The user could choose to search around system 100 to see if there are any media that satisfy his subscription criteria—or alternatively the user could place that subscription request so that any movies distributed in the future are automatically delivered to him at his device (such as device node 111), or another device in system 100 (e.g., device nodes 112-117).

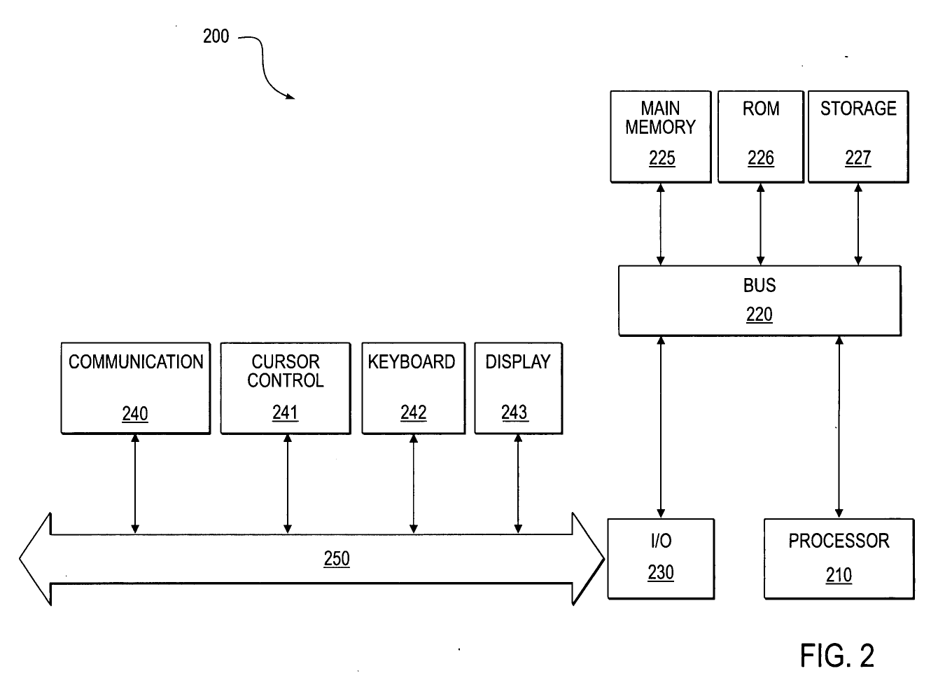

FIG. 2 illustrates an exemplary computer architecture for use with the present system, according to one embodiment of the invention. Computer architecture 200 can be used to implement a device node 111-117, or a network node 131-133 of FIG. 1. One embodiment of architecture 200 comprises a system bus 220 for communicating information, and a processor 210 coupled to bus 220 for processing information. Architecture 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Architecture 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Architecture 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, web pages and related information may be presented to the user on the display device 243.

The communication device 240 allows for access to other computers (servers or clients) via a network. The communication device 240 may comprise a modem, a network interface card, a wireless network interface or other well known interface device, such as those used for coupling to Ethernet, token ring, or other types of networks.

Each device node 111-117 may be a collection of devices. For example, in a home networking environment a personal media server stores media that is streamed via a home media network to a display device. The home network may be local private network that is separate from the Internet.

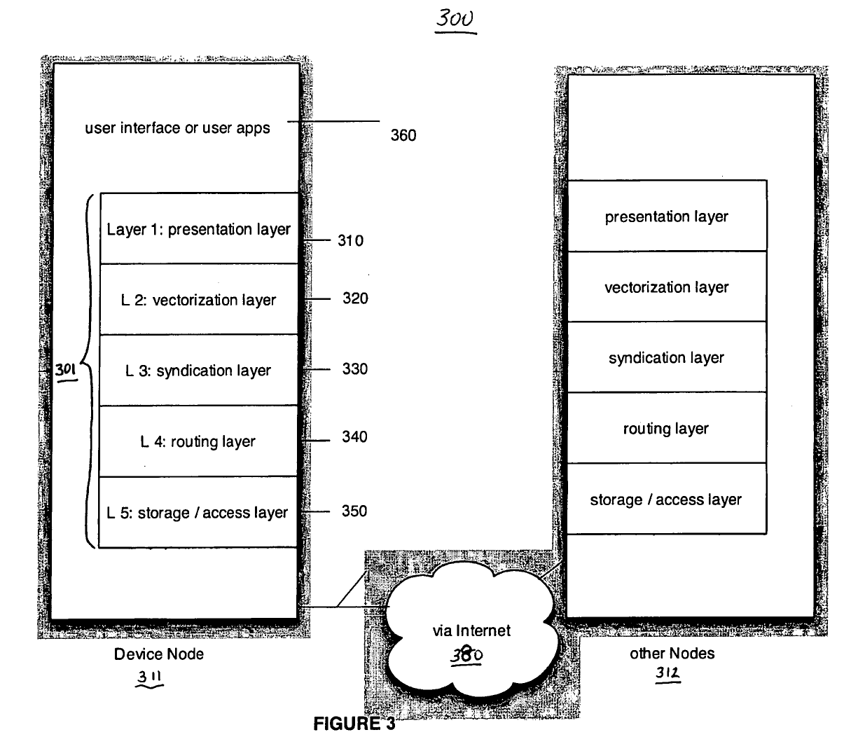

FIG. 3 illustrates a block diagram of an exemplary media distribution and publishing framework 301 within a system 300, according to one embodiment of the present invention. According to one embodiment, not all the layers of framework 301 need necessarily be present at each device in the network. The layers may be distributed, or a subset of layers are available. System 300 includes a device node 311 connected to other nodes 312, which could be other device nodes or network nodes. Device node 311 and other nodes 312 are interconnected via network 380, which is the Internet in one embodiment. Nodes 311-312 include a framework 301 for publishing and distributing media in system 300. The framework 301 includes a number of layers. These layers are:
Layer 1: Presentation layer, 310
Layer 2: Vectorization layer, 320
Layer 3: Syndication layer, 330
Layer 4: Routing layer, 340
Layer 5: Storage/Access layer, 350

Similar to the TCP/IP or OSI protocol stack, a given layer on device node 311 communicates with the corresponding peer layer in another device node 312, or network node, either directly or by sending information via adjacent layers. The user application or user interface 360 (such as an Internet browser) interfaces with system 300, typically, through the presentation layer 310. Vectorization layer 320 extracts details from media files 175 and instructs the presentation layer 310 to request any additional information. Syndication layer 330 when given a media file 175 finds the subscribing nodes that are interested in it (such as device nodes 111-117). Routing layer 340 processes a media file 175 into media file components depending on factors such as media format, media size, etc that are made available from vectorization layer 320. Storage/access layer 350 provides storage of media file components 175 within the device node 311 and other nodes 312, including network nodes. A more detailed description of layers 310-350 is provided below.

Network Access Information (NA)

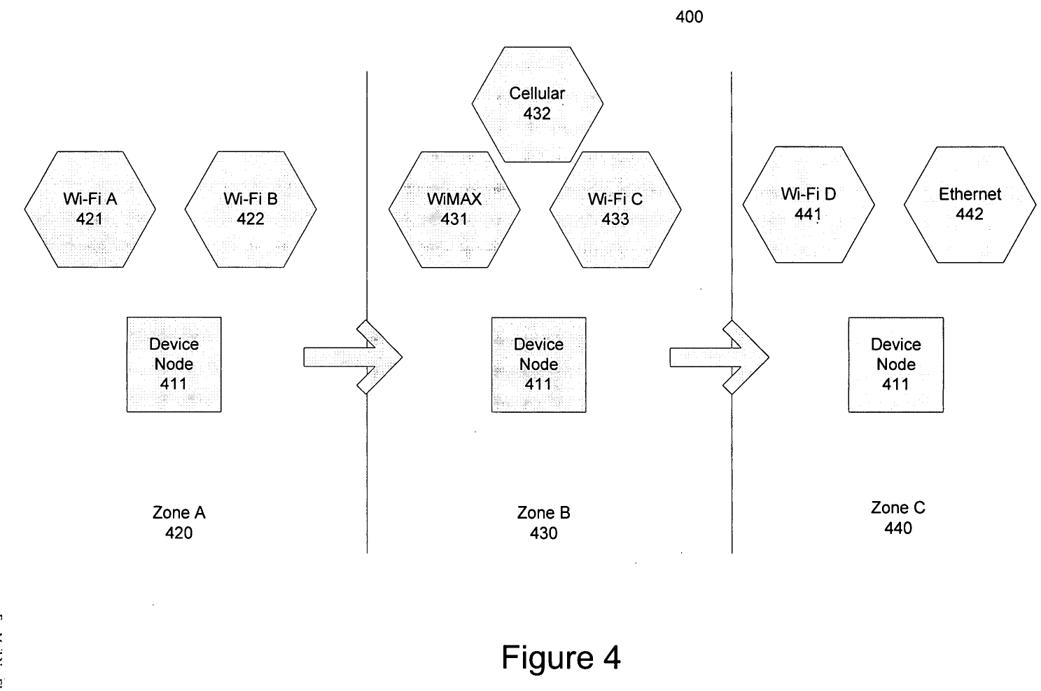

FIG. 4 illustrates a block diagram of a multimodal environment 400, according to one embodiment of the present invention. As the usage environment changes, the connectivity options change. For example, if a device node, such as device node 411, is a smart phone that is Wi-Fi enabled, it may access multiple Wi-Fi networks, such as shown in zone A 420 having Wi-Fi network A 421 and Wi-Fi network B 422. Device node 411, may accordingly have multiple Wi-Fi accounts. As device node 411 travels to zone 2, there are multiple connectivity options. For instance, in the case of a multi-modal device, such as a smart phone that in addition to its cellular capabilities, is also Wi-Fi enabled. Thus, in zone B 430, device node 411 must chose between Wi-Max network 431, cellular network 432, and Wi-Fi network C 433. In Zone C 440, device node 411 has the ability to connect to the Internet using Wi-Fi network D 441 or Ethernet network 442.

Device node 411 keeps track of the connectivity options available to it at any point in time as it moves between zones A-C 420, 430, 440. According to one embodiment, the various connectivity options are tracked using a connectivity function that is stored in the device node 411, that includes a connectivity variable set. One connectivity variable is the best connectivity variable that indicates the best connectivity option available at any time. Another connectivity variable in the set is the connectivity quality variable that indicates the quality of a particular connection.

The various connectivity options that are available to device node 411 are ranked. The various connectivity options of FIG. 4 include Wi-Fi network A 421, Wi-Fi network B 422, Wi-Fi network C 433, Wi-Fi network D 441, cellular network 432, WiMax network 431, and ethernet network 442. These options are ranked (possibly by the user, or an agent of the user), depending on factors such as the cost of the connection or the speed/capacity of that connection. An example of such an ordering could be: Ethernet→Wi-Fi A→WiMax→Wi-Fi B→cellular, which indicates that the wired connection is preferred to Wi-Fi, which in turn is preferred to WiMax, and so on. Thus, if node device 411 is in zone B 430 at a time when only-Wi-Fi network C 433, and cellular network 432 access is available, then, the best connectivity variable would indicate use of Wi-Fi network C 433.

Device node 411 also maintains a connectivity quality variable (or variable string), which provides information on the quality of the connection that node device 411 is likely to have at that moment in time. This quality information, for example, may be gathered by observing ping times and/or round-trip latencies to either specific destination nodes of interest, or to certain well-defined nodes in the network 100.

The data provided by connectivity function, the connectivity options and the connectivity quality variable, are by the device node 111-117 to decised when and how to communicate with the system 100. For example, when some value computed on the basis of the data, crosses some threshold, device 111-117 may decide to initiate a data transfer to the system 100. The computed values may also be passed on to the system 100, as part of a syncing operation where system 100 requests the device 111-117 to initiate certain activities, such as a media file download.

Maintaining Connectivity Between Devices and the System

Returning to FIG. 1, system 100 includes several device nodes 111-117 that may be mobile devices that move across different access networks or link layers such as device node 411 passing from zone A 420 to zone C 440. System 100 keeps track of device nodes 111-117 and maintains persistent connectivity, so that device nodes 111-117 have information on how system 100 (including network nodes 131-133) may be reached, and vice versa.

Device nodes 111-117 send beacons 190 periodically out to system 100, addressed to a system address. Beacons 190 may contain information such as, the device node identifier, and the device nodes' 111-117 current location. According to one embodiment, this is accomplished by including a particular device node's current IP address. If the location of the device node has changed since the last known address of that device, system 100 updates itself with the new node location. For example, in FIG. 4, if device node 411 moves from zone A 420 to zone B 430, system 400 updates itself with device node's 411 new location. System 100 maintains a location directory that contains the last observed location of a device node 111-117. Using the location directory, a device node may be able to reach any other node (whether a device node 111-117 or a network node 131-133).

A device node 111-117 addresses the beacon 190 to the system address available to it. The system address is either a hardcoded default network node address, or, when available, an efficient network node address. The network node 131-133 that the system 100 selects to be the most appropriate network node is called an efficient network node, according to one embodiment of the present invention. The system 100 may select the efficient network node based on the network topography and network traffic considerations.

It is possible that with time, a network node 131-133 selected to be the efficient network node for a particular device node 111-117, changes. In order to coordinate such a change, system 100 assigns a default network node 131-133 for every device node 111-117. The default node address is hardcoded in the memory of device node 111-117. System 100 updates device nodes 111-117 with an IP address of a more efficient network node 131-133 that is then cached by the device node 111-117, so that the next time the device node 111-117 needs to reach system 100, it uses the efficient network node 131-133 through the cached address. The default network node 131-133 also maintains a location directory linking the device node's identifier to the identifier of the efficient network node that has been assigned to that device.

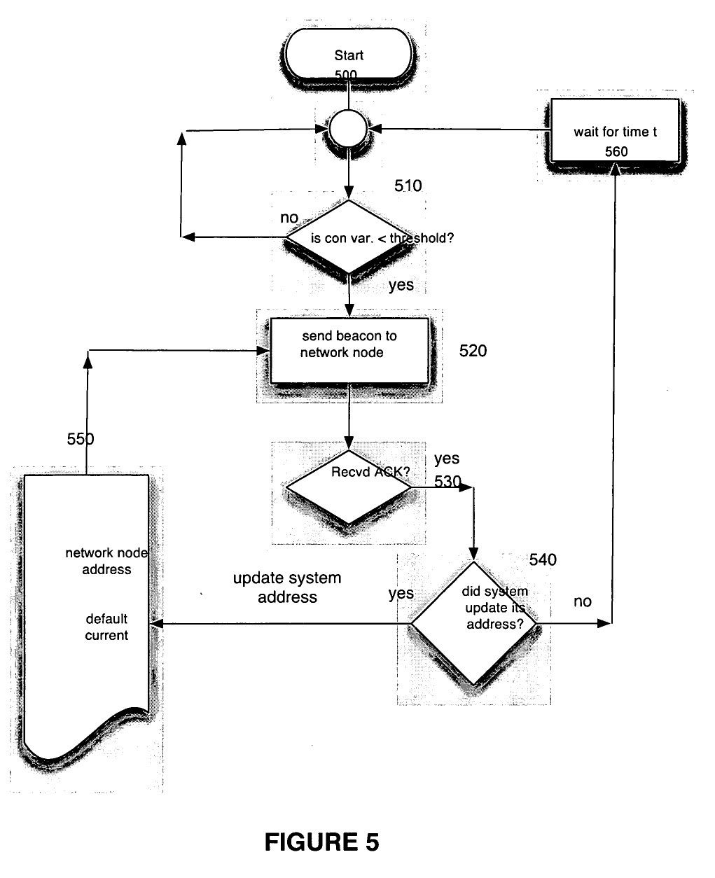

FIG. 5 illustrates a flow diagram of an exemplary network node assignment process 500, according to one embodiment of the present invention. Network node assignment process 500 determines when the connectivity variable is less than a configurable threshold value (510). If the connectivity variable indicates that a good connectivity option is available, a device node 111-117 sends a beacon 190 to the network node at the system address stored. (520) The device node 111-117 waits for an acknowledgement. (530) The beacon 190 contains the address of the network node 131-133. When an acknowledgment is received, the device node 111-117 looks at whether the network node 131-133 asked it to update its efficient network node addresses. (540) If so device node 111-117 caches the new address. (550) If not, the device node 111-117 waits for a configurable time, t, and then repeats the process 500 once again. If the network node did not send back an acknowledgement at decision block 530, the device node 111-117 will try to send the beacon 190 to the default network node address that has been hardcoded in it.

In reply to the beacon 190, a network node 131-133 either sends a no operation signal or some instruction to the address that the beacon 190 came from, such as to initiate some operation/process, or to update it with a new system address. If the beacon 190 from the device node 111-117 to an efficient network node indicates a different address for the device node, then the system would see if that the efficient network node continues to be efficient given the new device node address—and accordingly reply back to the beacon 190, with either a no operation signal or with an instruction to update with device with the new efficient network node address, and correspondingly, the system 100 would update its location directories with the most recent location of that network node.

System 100 maintains the location of device nodes 111-117. Since the number of nodes is expected to be large, the location directory that contains the location information for each device node 111-117 may be distributed among many network nodes 131-133. According to one embodiment, the directory information is distributed among multiple network nodes 131-133 by classifying device node identifiers into different classes or spaces.

Such classes or spaces could be based on device node's 111-117 attributes, such as its geographical location, network location, and/or some attribute of the device node identifier for that device. Each such class could have an associated efficient node address, that could be provided to all the device nodes that belong to that class. Each such class may contain a sub-directory that maps the device node identifiers to the physical location of those nodes. Such classes can be arranged hierarchically so that there may be classes that contain other classes. The top level root directory will contain the device node identifiers and the associated identifier of the class directory, that in turn contains information about that device node's 111-117 location. As a result, only when a device node 111-117 moves out of a class, does the directory information change for any of the directories above that of the class, that contains that device node.

In alternate embodiments, system 100 uses multiple tiers of such classes. Hence a class sub-directory could be acting as a root directory for that given class—and may maintain a set of sub-classes.

In alternate embodiments, the classification of device nodes 111-117 may be based on some common connectivity characteristic of the device nodes 111-117. These characteristics may include topography, upload or download bandwidth associated with nodes, the ISP serving the node, storage availability at the node (in this case the beacon 190 could optionally contain storage information as well). The classification may be based on the interconnectivity characteristic between that node and other nodes—so if a set of nodes can exchange information at a greater bandwidth with one another, they could be classified as such.

Media Processing and Host Directories

System 100 allows for a media file to be processed into components so that the media file can later be recovered from those components. System 100 includes a process media process for the generation of components. According to one embodiment, the media file is processed into media file components using methods such as Erasure Codes or by defining and reading a predetermined sequence of offsets from that file.

In another embodiment, a value or data that is needed to retrieve or consume a media file may be stored separately as a distinct media file component, such as a license or access media file component. An access media file component is made available to a requesting device node 111-117 upon its demonstration of having the required permissions, as a way to ensure that the copyrights for the media file are complied with.

The process takes as input, the media file name and some parameters describing the format of that media file and any preferences related to the way it should be processed. The output includes a set of media file components. The media file components may be assembled back into the media file, using an assemble media process. The resulting media file is a replica of the original media file. However, some processing technologies enable retrieval even if fewer than all the components are retrieved and used. In another embodiment, an assemble media process requires the consuming device node 111-117, or its agent, to demonstrate that it has the permission to assemble the media file back for consumption.

System 100 also allows for the processing of different and possibly conflicting media formats in the industry. The transform media file process is used to transform a media file from one format to another. Moreover, when media files are to be consumed by different kinds of device nodes 111-117—that may have different form factors, and processing capacities, transforms (also called transcoding) may be needed. In alternate embodiments, the functions described here can also be provided as third party applications to which the system can interface with. Other media processing and enhancing functions could similarly be included, or supported, by the system.

System Directories

Syndication Directories

The system maintains a set of directories. These include a media file directory, a subscription vector directory, and a subscription mapping directory. The media file directory maintains the mapping between media file identifiers and media file vectors. A media file identifier is generated by system 100, typically at the time that the media file 175 is made available to the system 100. It serves as a unique identifier of that media file 175. According to one embodiment, a media file vector is a set of attributes that describe the particular media file 175. Some examples of such attributes are size, play length, bit rate, title, genre, user generated tags, and user ratings.

The subscription vector directory maps the subscription identifier to the subscription vectors. Subscription identifiers are generated by system 100 when a subscription is created. A subscription identifier serves as a unique identifier of that subscription throughout the system 100. For example, a media publisher may create a subscription and insert media files 175 as part of that subscription. Another example is that a user may create a subscription with certain attributes, for example, movies that contain “Australia” and “bush walking.” Such attributes form the subscription vector, which is an array of attributes that describes that subscription. The intent is that, given the subscription identifier, one should be able to look up the appropriate vector associated with it. Similarly having identified a subscription vector, the associated identifier should be retrieved.

When a subscription is created, a subscription identifier is created and it has an associated subscription vector. The subscription vector may then be mapped to a node, so that the data that a node has subscribed for, may be delivered to the appropriate node. The subscription mapping directory maintains the mapping between the device node identifiers and the subscription identifiers, that the node has subscriptions for.

System Directories

System 100 also contains directories mapping the media file to its components and location of the components in the system. These directories are system wide. They are a media file system directory and a media file component system directory. The media file system directory is a global distributed directory containing the mapping between media files 175 and its component objects (component media files). Similar to the way in which node directories are organized among root and sub-directories, media file identifier-to-media file component identifier directories are also distributed, for instance, based on the characteristics of the characters composing the media file identifier.

The media file component system directory maps the media file component identifiers to the nodes where those media file components could be found. Hence with the knowledge of the node (either device node 111-117, or network node 131-133) where an media file component could be found, that media file component could be retrieved by looking into the media file component system directory.

Host Directories

Device nodes 111-117 hosts a media file to identifier host directory, an identifier to component host directory, and a component to location host directory. The media file to identifier host directory maps the file name of a given media file to the identifier associated with that file. An identifier to component host directory maps an media file identifier to the set of various media file components that comprises that media file. A component to location host directory maps each of the media file components to the location of that component, if it is stored in that host network node 131-133 (or device node 111-117).

Matching

System 100 uses a matching process that determines whether two vectors match based on certain matching criteria. Such processes may be implemented in one or more of the network nodes 131-133, using Java based technologies, such as EJB, J2EE and databases built using MySQL. Given a subscription vector, it can be determined whether a media file vector qualifies for the subscription based on a criteria provided as part of the subscription vector. For example, a subscription vector may be:

{subscription identifier = “23”, language = “english”, type =”comedy”,
rating =”> 400”, ......}.
Suppose some of the object vectors in the system are:
{.... Object identifier =”92”, language = “french”, rating “ “591”.....}
{.... Object identifier “302” language = “english”, rating = “22”...}
{.... Object identifier = “112”, language = “english”, rating ‘ “490”...}

The matching function indicates that the object vector, with object identifier of 112 is the only one that meets the criteria established by the subscription vector. Similarly, given a media file vector, system 100 determines which of the subscription vectors, if any, would match. According to one embodiment, the media file vector (or event) is matched with the subscription vectors, and vice versa, by comparing that event with each of the subscriptions. Network execution and updates of network indices

Processes in the syndication layer 330, routing layer 340 and storage/access layer 350 are executed over the network 380. Since parts of the data or processing resources are located at different nodes (whether device nodes 111-117 or network nodes 131-133), that are not necessarily well connected, the execution may happen over a period of time as and when the required devices/data/nodes become available. In this process, the connectivity variable set is used.

For example, the information mapping media files to its components in the media file-to-media file component host directory is synchronized with the information contained in the media file system directory about those components. This synchronization happens on the basis of the connectivity options available at that time, as indicated by the connectivity variable. When an appropriate connectivity option is available, the data is synchronized.

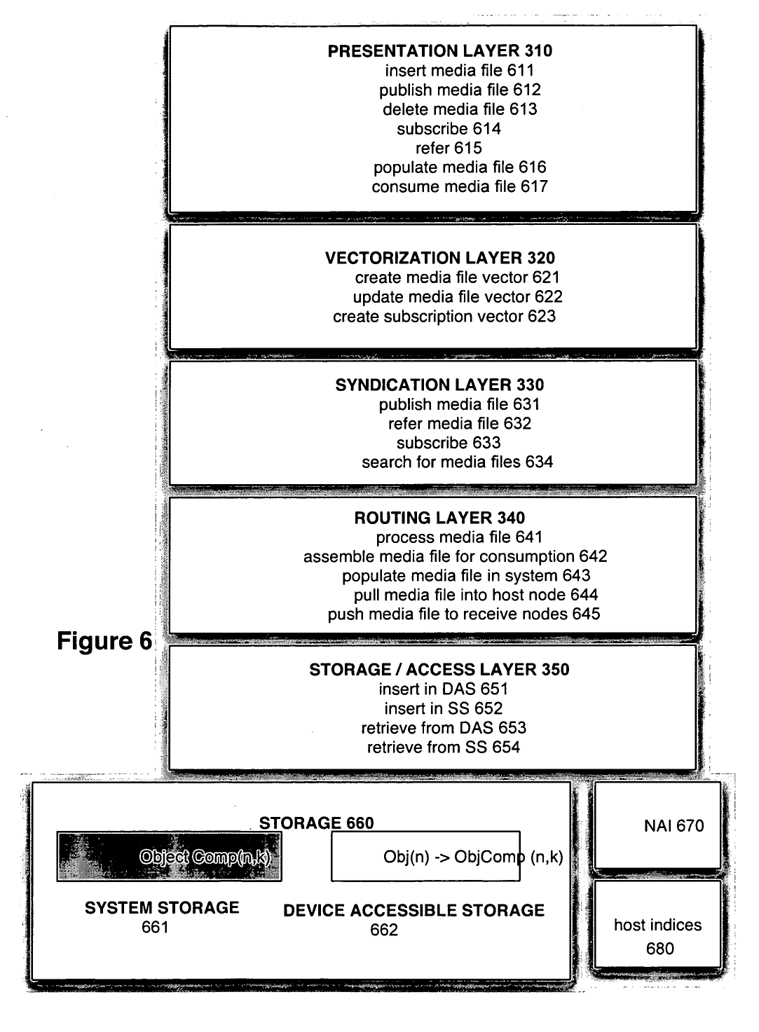

FIG. 6 illustrates a block diagram of the processes performed by the different layers of framework 301, according to one embodiment of the present invention. In alternate embodiments, a subset of layers of framework 301 are used.

### Presentation Layer 310

Users and user applications 360 interface with the system via the presentation layer 310. There are numerous processes associated with presentation layer 310. According to one embodiment, the processes are provided as application programming interfaces (APIs) to the user or user application 360. Using these APIs the presentation layer processes can be executed over a network, on a remote device node 111-117, or on a network node 131-133 provided by the system 100 for this purpose. For example, using a browser, a user could click on URLs, that embed commands to execute certain processes on a user interface server, which may be implemented on one or more of the network nodes 131-133. . Since these processes can be invoked remotely, the user need not be present at a device node 111-117 or a network node 131-133, in order to initiate processes, such as those below.
(a) insert media file process 611
(b) publish media file process 612
(c) publish delete process 613
(d) subscribe process 614
(e) refer process 615
(f) populate media file process 616
(g) consume media file process 617
   Insert Media File Process 611

When the user associated with a device node 111-117 wishes to make a media file available for others, that user invokes the insert media file process 611. According to one embodiment, the user initiates the insert media file process 611 thorough a user interface 360 (such as Internet Explorer), or through a user level application 360. According to one embodiment, the user clicks on the media file's icon on his desktop and “drags and drops” it into a specified area that initiates the insert media file process. The insert media file process 611 extracts information about the media file 175 such as size of the media file, the media file format, date created, etc. The insert media file process 611 generates a pop-up window to request further information from the user about the media file 175. Publishing a media file 175 involves generating a media file vector (media file vector) which contains values associated with a set of attributes that help describe that media file (e.g., metadata) along with an identifier for that media file 175 (media file identifier).

A media file vector is created using a vectorization layer 320 process such as a create media file vector process 621, based on a combination of user inputs (manually or via other applications, and data sources) and automatic extraction by the presentation layer 310 (e.g., for details such as size of media file, format of the file, etc). The media file vector includes fields provided for use by the author to indicate the identity of receiving nodes (whether device nodes 111-117 and/or network nodes 131-133), or access rights required for a recipient to be able to use or consume that media file. The insert media file process 611 also executes a routing layer 340 process such as a process media file process 641, to generate the components that comprise the media file. The insert media file process 611 updates the media file-to-identifier host directory entry that maps the media file's name to the media file identifier.

Publish Media File Process 612

The publish media file process 612 makes the inserted media file available for consumption by the appropriate subscribers. The publish media file process 612 updates the media file vector and sets a flag in the media file vector which indicates that it is now available for consumers. This is done using the update media file vector process 622 which is a vectorization layer 320 process.

The publish media file process 612 then runs a publish media file process 631 of the syndication layer 330, which takes the media file vector and matches it with various subscription vectors to arrive at a subscription identification. This is accomplished using a media file vector to subscription identification directory. From the set of subscription identifiers, the publish media file process 612 obtains a set of receiving nodes using the subscription identifier to receiving node directory. The publish media file process 612 executes a routing layer 340 process, push media file to receiving nodes process 645 that sends the media file to the interested receiving nodes (e.g., device nodes 111-117).

Delete Media File Process

A delete media file process 613 modifies the media file vector, using an update media file vector, and sets off a flag that prevents a media file from being sent to any of the subscribing nodes.

Subscribe Process 614

A subscribe process 614 allows the user, or user application 360, to subscribe to media files 175. The subscription could either be on the basis of providing a subscription identifier, of a well-known subscription (i.e., a pre-existing subscription know in advance to the system and the user), or, by using a create subscription vector, that defines a set of variables, which together create a subscription vector. The subscribe vector may also contain information related to any relationship, such as a Boolean relationship, requirements among the values comprising the subscribe vector.

Once a subscription vector is created, its identifier has to be mapped to the device node 111-117 that wishes to subscribe. This is accomplished using the subscribe process. A device node 111-117 may also subscribe for another device node 111-117 if it has the necessary permissions. For example, the same user may be using multiple device nodes 111-117, or a device node 111-117 may have permitted a set of other device nodes 111-117 to subscribe on its behalf.

Refer Media File Process 615

A refer media file process 615 allows for the user to refer another user(s) to a particular media file 175. The referral could involve either simply informing the other user about that media file 175, or it could, in addition, send some of, or all of, the given media file 175 to a device node 111-117 associated with that other user. The refer media file process 615 takes as input, the media file identifier and a variable(s) whose value indicates whether the recipient user should be informed about the media file, or whether the media file information should proactively be delivered to a device node 111-117 associated with that user. The refer media file process 615 invokes a syndication layer 330 process, refer media file syndication process 632, which will send or inform the recipient device node 111-117 about the referring user's message.

Populate Media File Process 616

A populate media file process 616 is initiated by the user via a user interface 360 so as to populate system 100 with the media file's components, such that it is easily available to the potential receiving device nodes 111-117. The populate media file process 616 also controls the way the media file 175 is distributed within system 100. For example, the distribution parameters may include how widely and in which topographies the media file 175 is to be distributed. The populate media file process uses a routing layer 340 process for populating the media file in system 100, such as populate media file in system process 643.

Consume Media File Process 617

A consume media file process 617 allows the device node 111-117 to retrieve the media file 175, or its components, from the device accessible storage 662. According to one embodiment, digital rights management is instituted to check permissions of the device node 111-117 to consume the media file 175.

### Vectorization Layer 320

Create Media File Vector Process 621

A create media file vector process 621 is responsible for extracting details from the media file's filename and to instruct presentation layer 310 to get details it does not have. The create media file vector process 621 is customized for different kinds of media applications. According to one embodiment, the fields that are part of this media file vector are based on standards developed by third parties, such as VoD Metadata (www.cablelabs.com/projects/metadata/) or in alternate embodiments, the fields of the media file vector are proprietary definitions. In one embodiment, the media file vector is formatted in the form of an XML file. The media file identifier and media file vector generated by the create media file vector process 621 are used to create/update the media file-to-media file identifier host directory and media file-to-media file component directory.

Update Media File Vector Process 622

The update media file vector process 622 updates a media file vector using the media file identifier or filename as an input to the media file-to-media file identifier host directory and media file-to-media file component directory.

Create Subscription Vector Process 623

The create subscription vector process 623 is similar to the create media file vector process 621. The create subscription vector process 623 creates a subscription vector upon instruction from the subscribe process 614-using the appropriate metadata formats.

### Syndication Layer 330

According to one embodiment, the processes of syndication layer 330 are executed by network nodes 131-133. However, in alternate embodiments, some or all of the syndication layer processes are also executed in device nodes 111-117.

Publish Media File Syndication Process 631

The publish media file syndication process 631 when given a media file 175 finds the subscribing device nodes 111-117 that are interested in it. Using the media file identifier as an input, the publish media file syndication process 631 retrieves the media file vector from a syndication media file-to-media file identifier directory. The publish media file syndication process 631 uses a matching process to get the list of subscription vectors that matches with media file vectors. Then, using the list of subscription vectors from the media file vector-to-subscription vector directory, the publish media file syndication process 631 determines the subscription identifiers for the particular media file. The publish media file syndication process 631 looks up the subscription identifier-to-receiving node directory to determine the list of receiving nodes that should receive this media file 175. In order to send the media file 175 to those receiving nodes, it executes a routing layer 340 process, such as push media file to receiving nodes process 645.

Refer Media File Process 632

The refer media file process 632 receives some identification of receiving node(s) that are interested in a given media file. The refer media file process 632 manages the delivery of the media file to the receiving device nodes 111-117 thus identified, using the push media file to receiving nodes process 645.

Subscribe Process 633

The subscribe syndication process 633 is initiated by subscribe process 614 of the presentation layer 310. The subscribe syndication process 633 links subscriptions to receiving nodes. This is done by updating the subscription identifier-to-receiving node directory to indicate the mapping between the subscription identifiers and the appropriate receiving nodes.

Search for Media Files Process 634

The search for media files process 634 when provided a subscription vector or subscription identifier, runs a matching process to search for media file vector(s). Using the syndication media file-to-media file identifier directory, the search for media files process 634 returns the set media file identifiers of the media files 175 that match that subscription. The search for media files process 634 is used when a new subscription is created and media files 175 matching that subscription need to be identified. Those media files 175 could then be pulled into the nodes (e.g., device nodes 111-117 and network nodes 131-133) that are associated with the subscriptions.

### Routing Layer 340

Process Media File Process 641

A process media file process 641 processes the given media file into media file components depending on factors such as media format, media size, etc that are made available from the vectorization layer 320. The resulting set of media file components is stored and the media file-to-component host directory and component-to-location host directory are updated. The storage of media file components is accomplished using the storage/access layer 350 processes insert in DAS process 651 and insert in SS process 652, depending on where the media file components are stored.

Assemble Media File for Consumption Process 642

An assemble media file for consumption process 642 combines the media file 175 from its media file components so that it can be consumed. As noted earlier, according to one embodiment, digital rights management requirements are introduced using the assemble media file for consumption process 642.

Populate Media File in System Process 643

A populate media file in system process 643 is used when the distributor of a media file 175 distributes the media file 175, or its media file components, within the system 100 even before it is available for consumption. The populate media file in system process 643 is used to disseminate the media file 175 and makes it accessible to subscribers. According to one embodiment, the dissemination is scheduled to occur at a time when network traffic is lighter. The populate media file in system process 643 may be used to store media files out in network nodes 131-133, as opposed to devices nodes 1111-117, thereby leveraging the vast amounts of storage that is available in a distributed system 100. According to another embodiment, the populate media file in system process 643 accepts criteria indicating the way the media file or its components should be distributed.

As an example, the way in which the media file components are pre-populated in system 100 may be based on the following factors:
preference indicated from the a layer 310-350, for any media file 175 (for example for commercial/paid content). The preference could be in the form of information on the “rate” of distribution, indicating how widely that media file 175 should be distributed.
ensuring a reasonable amount of certainty of retrieving a given media file component (so as to limit the reliance on a specific node or nodes)
based on information of any specific node/nodes (e.g., device nodes 111-117 or network nodes 131-133) that are likely to request that media file 175. This can be based on an analysis of previous request behavior from the device node 111-117, topological or demographic information.
distributing certain media file components (for example those comprising the initial parts of a movie) at higher rates, or proactively distributing media file components that are not sufficiently available. In this case, the populate media file in system process 643 is modified such that those media file components could be identified as part of the input.

Hence the populate media file in system process 643 determines the set of receiving nodes that should receive the media file 175 or its components. The push media file to receiving nodes process 645 sends the media file to the selected set of receiving nodes.

Pull Media File into Host Process 644

The pull media file into host process 644 efficiently moves the media file components comprising the required media file 175 into a specified node (e.g., either device nodes 111-117 or network nodes 131-133).

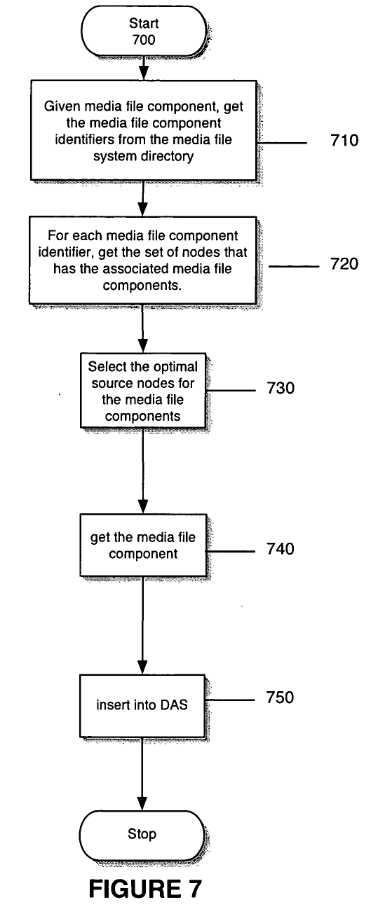

FIG. 7 illustrates a flow diagram of an exemplary process for moving media file components into a node, according to one embodiment of the present invention. Given the media file identifier, the set of components identifier is derived from the media file system directory (710). For each media file component identifier a set of nodes (e.g., either device nodes 111-117 or network nodes 131-133) is provided that stores the component identified by the media file component identifier, from the media file component system directory. (720)

If there is more than one node that has the media file component, system 100 determines the optimal node to receive that media file component from. (730) According to one embodiment, system 100 picks a random node. If the throughput rate is less than a threshold, then system 100 selects another random node from the set of nodes, and so on until an adequate node is located. In an alternate embodiment, the receiving host sends an identical test data block to a set of the nodes identified as having the media file component, and thereby determines the round-trip time and the loss rate of the test data block. The receiving host selects the node that offers the best connection. According to another embodiment, an equation is used such as the TCP Friendly Rate Control (TFRC) algorithm that computes the sending rate that will lead to better performance.

According to another embodiment, the system 100 simultaneously receives the medial file component from multiple senders, each of which has the media file component. A rate allocation algorithm and packet partitioning algorithm is used to select and download the media file component from different senders. The media file component is received by the node (740), and the insert in DAS process 651 is executed for storing the media file component in the receiving host node's storage area. According to one embodiment, processing blocks 720 through 750 are executed in parallel for each of the different media file components (as indicated by the media file component identifier values) transferred to the receiving node.

Push Media File to Receiving Nodes Process 645

The push media file to receiving nodes process 645 uses the media file identifier to retrieve the media file components comprising a particular media file 175. According to one embodiment, the media file components reside at the same single source node and they are sent to a set of receiver nodes. According to one embodiment, sending the media file components to the receivers is as follows. Given m components at the source node, and n receivers, the receiver nodes are grouped into sets of m nodes each, such that nodes in each set have a high degree of inter-connectivity with other nodes in the same set. Inter-connectivity is measured on the basis of round-trip times and loss rates. Since nodes within the same physical sub-network (such as within the same ISP) are likely to have high inter-connectivity, sets of nodes within the same subnet are grouped together and tested to determine whether their inter-connectivity value is above a configurable threshold value. One of the sets will have less than m nodes if n is not an integral multiple of m.

Next, the sets are arranged in the decreasing order of their connectivity value to the source node. The nodes in each set are arranged in a circular namespace. The source node sends its m components to the m nodes in the first set and then to m nodes in the second set, and so on. Each node in a set sends the media file component it received to the node to its right in the circular namespace and receives another component from the node to its left. Once the function of the node in a given set is completed (i.e., when it and its neighbor to its right have received all the components), it falls out of the set and joins the source in being available as a source in its own right.

If any nodes were not able to get any of the necessary components as part of the overlay within a configurable threshold of time, the node falls out of the set process and request for that particular media file component from one of the source nodes, by using the pull media file into host node process 644. If there are multiple nodes (e.g., either device nodes 111-117 or network nodes 131-133) that have some or all of the media file components, then the optimal sending device for each set is determined and the media file components are sent from each optimal device to the corresponding set, in parallel.

Since system 100 may employ a push based delivery model, using subscriptions or referrals, the system 100 identifies the set of device nodes 111-117 that would need to receive a media file 175 before the media file delivery is initiated. The ability to aggregate the set of receiving nodes before starting the media file push process, may result in more efficient delivery of the media file 175, where efficiency may be measured in terms of system resources, system performance, bandwidth, storage and delivery costs. Such efficiency results from factors such as (a) the system's ability to collect more details on characteristics of the device nodes 111-117 before the delivery is initiated; and (b) the system's ability to aggregate a large number of potential receiving device nodes as a result of the various processes above the routing layer 340.

### Access/Storage Layer 350

The access/storage layer 350 deals with the storage of media file components, within a device node 111-117 and the various network nodes 131-133. The storage area 660 is virtually divided into two areas. Device accessible storage (DAS) 662 is accessible to the device node 111-117 that is hosting that storage. Media file components in system storage (SS) 661 are not generally meant for the consumption of a device node 111-117. The system 100 can access the entire storage area 660 in the device node 111-117.

Media file data is stored in media file components and the component to location host directory is an index that contains the directory mapping of a media file component to its location in the DAS 662 or in the SS 661. The fact that a media file component is stored in that node device 111-117 is revealed by the media file to component host directory or media file system directory.

Insert in DAS Process 651

The insert in DAS process 651 stores the media file components in the device accessible storage (DAS) and updates the media file to component host directory or media file system directory. Since the media file system directory is a system wide index, updating that involves using the network access information data 670 to check for connectivity options available.

Insert in SS Process 652

The insert in SS process 652 stores media file components directly in the system storage 661. A network node 131-133 requests the device node 111-117 to store a media file component by executing the insert in SS process 652. The insert in SS process 652 may be initiated by the device node 111-117 that is inserting a media file into system 100 via an option presented to the user, or user application 360. The media file components need not be staged in the host network node before being distributed in the system 100. Since system storage 661 is a network level resource—this will be a network execution.

Retrieve from DAS Process 653

The retrieve from DAS process 653 when given the media file component identifier retrieves the media file component using the media file component to location host directory. According to one embodiment, digital rights management is implemented with this process.

Retrieve from SS Process 654

The retrieve from SS process 654 given the media file component identifier looks for the best available node to retrieve the media file component from using the media file system directory.

In alternate embodiments, not all the layers of framework 301 need to be executed on the same physical device. For example, one could refer or subscribe to a system 100 using a presentation layer, that runs on one device node, other than the one in which the storage processes are executed. In one embodiment, a user X, of system 100 may register with system 100 with more than one device nodes 111-117. The user may then indicates his/her interest in receiving a media file 175, by providing the system 100 with a media file identifier. Alternatively another user, Y, of system 100 may have refered the media file 175 to user X. The system 100 decides which of the device nodes 111-117 that user X has already registered, should receive the media file 175. For example, this decision may be made on the basis of a preferred device that user X configured in advance. Another example, involves detecting characteristics of the media file 175, and based on that, evaluating which of the device nodes 111-117 registered by user X best match that characteristic.

Having described embodiments of the present system and processes, system usage examples are provided for illustrative purposes.

### EXAMPLE 1

### A User Subscribing to Content

The user uses his IP device node 111-117 to describe attributes of a media category or type that he is interested in. The user may indicate an interest in subscribing to media that are (i) movies, (ii) recommended by Discovery Channel and (iii) about African wildlife and (iii) produced in the last 3 years. Through an appropriate user interface 360 on the device node 111-117, which initiates the subscribe process 614 on that device node 111-117, the user inputs these attributes. A subscription vector is generated by system 100 using the create subscription vector process 623.

The user could choose, via the interface 360 provided by subscribe process 614 to search around system 100 to see if there are any media that satisfy the subscription criteria—or alternatively the user places that subscription request with system 100 so that any movies distributed in the future are automatically delivered to him at the device node 111-117, or another device of his choice.

Suppose that the user wishes to see what movies in the system satisfy the subscription criteria. Subscribe process 614 initiates the search for media files process 634 which returns the list of media files (e.g., by media file identifier) that satisfy the criteria. Then the pull media file 175 into host process node 644 is executed for each of the media files of interest. The various media file components comprising those media files are identified and pulled into the host from various nodes that may be storing those media file components. Once the media file components are retrieved, they are inserted into the device node 111-117 storage 660 in the DAS 662, using the insert into DAS process 651.

When a media file 175 of interest is available at the device node 111-117, the user is notified through the user interface 360, and the consume media file process 617 is executed to check the rights of the user to consume, and then assemble the media file so that the device node 111-117 can play it.

In an alternate embodiment, subscription vectors do not have to be created newly by the user. There can be well-known subscriptions, whose subscription identifiers can be published by third parties—and the user can simply subscribe to them using those identifiers.

In another alternate embodiment, a user subscribes to a media file 175 such that it gets retrieved to a device node 111-117 other than a device node that is used to create the subscription request. The user interface 360 on the device node 111-117 provides an option as part of executing the subscribe process 614 which allows the user to identify the device node 111-117 that will receive the media. Possibly, the user will have to register the different device nodes 111-117 with system 100, that are to be considered as part of the system 100. An example of such a scenario is a user subscribing using a cell phone to receive the movies on a personal video recorder connected to a television at home. The user may also obtain a specific media file using some identifier for that media file by indicating that as part of the subscription vector.

### EXAMPLE 2

### A Media Distributor Placing Content on the Network

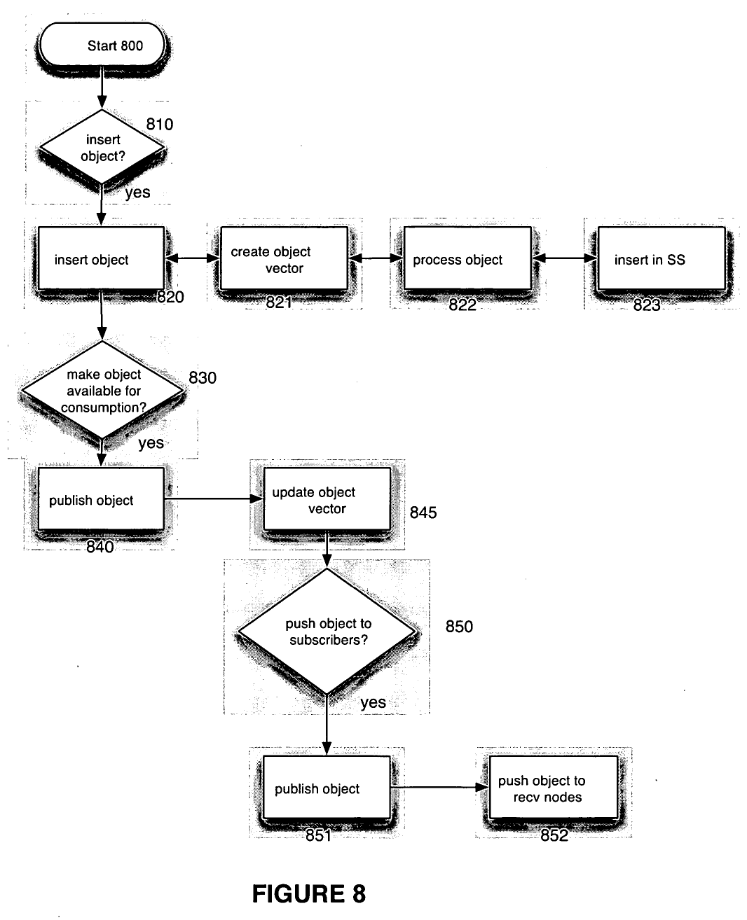

FIG. 8 illustrates a flow diagram of an exemplary process for publishing a media file, according to one embodiment of the present invention. The user through user interface 360 or a software package running on a device node 111-117 connected to the Internet 150 indicates the media file 175 that needs to be published (810). The system 100 initiates the insert media file process 611 (820). The media file vector is created (821) using a combination of media file parameters that are automatically extracted, and parameters that are requested back from the user. Next, the media file 175 is processed (822) into media file components which are then inserted in storage. According to this embodiment, the media file components are to be stored in system 100 and so the insert in SS process 652 (823) is executed. Since this is a network execution, the media file components are sent out to the storage 661 within the network as and when the appropriate level of bandwidth is available to the device node 111-117. Optionally, the media file 175 could be stored within the device node 111-117 itself.

Next, the user makes the media file available for viewing (830). This could involve setting conditions, restrictions, rights and payment information for viewing by other parties, which is entered using the publish media file process 612 (840) and is accordingly modified via the update media file vector process 622 (850). Any subscribers that are searching for media files will then be able to find out about this media file 175.

The user may require that the media file be pushed out to the appropriate subscribers. Also the user may set a certain time at which the pushing should be repeated (such as every day or every hour, etc). The publish media file process 612 (851) checks to see the receivers (e.g., device nodes 111-117) that have matching subscriptions. The push media file to receiving nodes process 645 (852) sends out the media file 175 which is stored in the device node 111-117.

The media file 175 is stored in the device node 111-117 at a time when the device node 111-117 is in an area where it has a selected kind of access, and it remains available for the user even when he is not in that area. According to one embodiment, the user's device node 111-117 is downloaded with the Fox sports media when the user is at work and the user can later view it when in the subway (where there is no network access), or perhaps when in the car (where a more expensive cellular access is available which can optionally be used for digital rights verification which tends to be less data intensive).

### EXAMPLE 3

### A Mobile Device User Subscribing to Fox Sports Highlight Videos

In this example, a major content vendor, say Fox Sports, creates a daily video snippet about the highlights of recent sporting events. Fox places the content on the system and creates also creates a subscription vector that uniquely identifies this series of videos. Fox then makes the subscription identifier for this vector well known. The identifier could be made available and accessible through a user-friendly manner that hides the technical details. A version of this video series is available in a format suitable for viewing over a mobile device.

A mobile customer can now subscribe to this vector by adding their name to this subscription using subscribe process via a user interface 360. The user has a multi-modal device that has both Wi-Fi and cell phone access. Suppose that cellular data costs money whereas Wi-Fi is free but available only at home or at work. The user can indicate this to the system 100, which sets the network access information thresholds accordingly.

The network access information processes 670 keeps checking the access options periodically and when it is in a Wi-Fi zone the search for media files process 634 is initiated. The system 100 then looks for the best placed media file components for the media files of interest and they are then sent to the device node 111-117.

### EXAMPLE 4

### Gamefly

To illustrate this usage example, a service provider called Gamefly (www.gamefly.com) is used for illustrative purposes only. In alternate embodiments, the principles described here could be applied to other similar service providers, for games as well as other movies.

Gamefly offers a service where people rent games for a monthly fee and deliver the games by mail. The consumer creates a “GameQ” that ranks the games that the consumer is interested in. As soon as the user returns a game by mail, the next game from his GameQ is sent out. In a way, it is similar to Netflix. (www.netflix.com)

System 100 allows for an alternate distribution channel, such as a ‘Gamefly Direct’ channel for delivering games via IP to gaming consoles and personal computers. Current and future users can choose this package by clicking a button on the gamefly webpage, similar to the current model (paying $21.95 for 2 games a month). System 100 checks the GameQ for the user preferences, and sends the movie that is next. The user plays this game in that specific gaming console and cannot make copies of it or distribute it to anyone else. When the user is done playing that game, he/she may click on a ‘return the game back to Gamefly’ icon—at which point the game becomes inaccessible—and in its place a new game from the GameQ appears instantaneously on the console, assuming that the game has been loaded into the console based on the preferences available on the GameQ. On the other hand, if the user clicks on the ‘Keep It’ button, the game is available for storage and the user can have all rights and privileges associated with owning a game. Gamefly (or another entity) can debit the user's credit card. Based on the user's historical usage, Gamefly sends trailers of games that the user may be interested in. These trailers are pre-loaded by the time they appear on the user interface 360.

If the customer, A, finds a game to be really nice and wants to refer it (or play it) with his buddy, B, the customer A sends a message to B who is also a ‘Gamefly Direct’ subscriber. Subscriber B, later finds the message on his/her gaming console—and decides to check it out. Subscriber B clicks ‘Rent it or Buy it’ and instead of waiting for that game to be downloaded—he/she finds that game already available and ready to play, assuming that system 100 had enough time to get the game into B's device node 111-117 before B logged-on.

### EXAMPLE 5

### A Person Selecting a Video While He is with His Friends at a Bar

In this example, user A is with his friends at a bar. His friends tell him that they recently saw a movie called Junebug that was really nice. He takes his cell phone and dials into the system (or sends an SMS to the system) indicating that he wishes to see Junebug. The system now searches using keyword, title=“Junebug” and identifies the media file associated with that attribute. User A has also indicated that the primary device where he would like to see movies is his home TV connected to an Internet enabled PVR (or some harddisk connected to his TV). The system now delivers Junebug to his home so that it is waiting for him when he gets back. In this example, it is assumed that the rights owner of the movie Junebug, had made that media file available to the system, for delivery to people who request it, just like the user A above.

### EXAMPLE 6

### A Hotel Subscribing to Top 10 Romantic Movies, as Defined by About.com

About.com maintains a list of the top movie categories, such as the top romantic ones found at http://homevideo.about.com/cs/romantic/tp/romanticmovies.htm

A hotel that wishes to attract the honeymoon clientele, could have their device subscribed to the top 10 romantic movies. The system will maintain the top 10 list, at all times, and when a movie is added that will be delivered to that device and when it is deleted from the above list, it will be deleted. In this example, About.com doesn't necessarily need to have any relationship with the media rights owners—they are only an opinion leader, putting out their top 10 lists. However, with a single operation by the user, our system can use some recognition technique to check if the media files indicated in that list exist in the system, and if so, deliver the corresponding media files to the indicated device or devices.

### OTHER ALTERNATIVE EMBODIMENTS

According to one alternative embodiment of the present invention, the distributed system 100 can be composed of different sub-networks, that may only be occasionally connected to one another and the devices composing the sub-networks can be dynamic and change with time—with member devices moving between one sub-network to another.

For instance, a set of devices inside an airplane could form a network that runs this system allowing those devices to share and exchange media files. None of the devices may be on the Internet during the flight. When the plane lands, and the devices are connected to the Internet, they sync up the new media file components that they have obtained during the course of the flight with other sub-networks that they then become part of, which could include the Internet.

A method and system to facilitate publishing and distribution of digital media have been disclosed. Although the present methods and systems have been described with respect to specific examples and subsystems, it will be apparent to those of ordinary skill in the art that it is not limited to these specific examples or subsystems but extends to other embodiments as well.

1. A method, comprising:
receiving via a network, parameters describing a category of media files;
identifying one or more media files corresponding to the category of media files as the one or more media files become available on the network; and
pushing the one or more media files to a device node according to the parameters, wherein the parameters include connectivity parameters.

2. The method of claim 1, wherein the parameters are user configurable based on genre, recommendations, media type, and production date.

3. The method of claim 2, wherein the parameters include distribution parameters that describe how widely the one or more media files are to be distributed.

4. The method of claim 2, further comprising aggregating parameters from multiple users, wherein the parameters from multiple users are related.

5. The method of claim 1, further comprising pre-populating the network with the one or more media files based on the parameters.

6. The method of claim 5, wherein pre-populating the network further comprises storing the one or media files on one or more additional device nodes attached to the network, wherein each network device node includes a user viewable storage area and a non user viewable storage area.

7. The method of claim 6, further comprising allowing a user to view a non user viewable media file stored in the non user viewable storage area once the user requests to view the non user viewable media file.

8. The method of claim 6, wherein parts of the one or more media files are stored on the one or more additional device nodes attached to the network.

9. The method of claim 1, wherein the device is a default device selected from multiple devices associated with a user.

10. The method of claim 1, wherein pushing the one or more media files is optimized based on bandwidth capabilities of the device, storage capabilities of the device and bandwidth capabilities of available connections to the device.

11. The method of claim 1, further comprising measuring usage of the one or more media files to determine a usage measurement, and determining a popularity rating of the one or more media files.

12. The method of claim 11, further comprising populating the network with additional copies of the one or more media files based on the usage measurement and the popularity rating.

13. The method of claim 11, further comprising generating recommendations based on the usage measurement, the popularity rating, and the parameters.

14. The method of claim 1, further comprising restricting access to the one or more media files based on permissions and digital rights management.

15. The method of claim 1, further comprising billing for the one or more media files.

16. The method of claim 1, wherein the media files include videos, music, audio books, home movies, photos, data files, and video games.

17. The method of claim 1, wherein multiple users desiring a similar category of media files are aggregated into a group and the one or more media files are pushed to the group.

18. The method of claim 1, wherein one or more of the parameters describing the category of media files is provided by a plurality of actions, the plurality of action including clicking on an icon on a website, placing a phone call, sending an e-mail, and sending a text message.

19. A computer-readable medium having stored thereon a plurality of instructions, said plurality of instructions when executed by a computer, cause said computer to perform:
receiving via a network, parameters describing a category of media files;
identifying one or more media files corresponding to the category of media files as the one or more media files become available on the network; and
pushing the one or more media files to a device node according to the parameters, wherein the parameters include connectivity parameters.

20. The computer-readable medium of claim 19, wherein the parameters are user configurable based on genre, recommendations, media type, and production date.

21. The computer-readable medium of claim 20, wherein the parameters include distribution parameters that describe how widely the one or more media files are to be distributed.

22. The computer-readable medium of claim 20, having stored thereon additional instructions, said additional instructions when executed by a computer, cause said computer to further perform aggregating parameters from multiple users, wherein the parameters from multiple users are related.

23. The computer-readable medium of claim 19, having stored thereon additional instructions, said additional instructions when executed by a computer, cause said computer to further perform pre-populating the network with the one or more media files based on the parameters.

24. The computer-readable medium of claim 23, having stored thereon additional instructions, said additional instructions when executed by a computer for pre-populating the network, cause said computer to further perform storing the one or media files on one or more network device nodes attached to the network, wherein each network device node includes a user viewable storage area and a non user viewable storage area.

25. The computer-readable medium of claim 24, having stored thereon additional instructions, said additional instructions when executed by a computer, cause said computer to further perform allowing a user to view a non user viewable media file stored in the non user viewable storage area once the user requests to view the non user viewable media file.

26. The computer-readable medium of claim 24, wherein parts of the one or more media files are stored on the one or more network device nodes attached to the network.

27. The computer-readable medium of claim 19, wherein the device is a default device selected from multiple devices associated with a user.

28. The computer-readable medium of claim 19, wherein pushing the one or more media files is optimized based on bandwidth capabilities of the device, storage capabilities of the device and bandwidth capabilities of available connections to the device.

29. The computer-readable medium of claim 19, having stored thereon additional instructions, said additional instructions when executed by a computer, cause said computer to further perform measuring usage of the one or more media files to determine a usage measurement, and determining a popularity rating of the one or more media files.

30. The computer-readable medium of claim 29, having stored thereon additional instructions, said additional instructions when executed by a computer, cause said computer to further perform populating the network with additional copies of the one or more media files based on the usage measurement and the popularity rating.

31. The computer-readable medium of claim 29, having stored thereon additional instructions, said additional instructions when executed by a computer, cause said computer to further perform generating recommendations based on the usage measurement, the popularity rating, and the parameters.

32. The computer-readable medium of claim 19, further comprising restricting access to the one or more media files based on permissions and digital rights management.

33. The computer-readable medium of claim 19, having stored thereon additional instructions, said additional instructions when executed by a computer, cause said computer to further perform billing for the one or more media files.

34. The computer-readable medium of claim 19, wherein the media files include videos, music, audio books, home movies, photos, data files, and video games.

35. The method of claim 19, wherein multiple users desiring a similar category of media files are aggregated into a group and the one or more media files are pushed to the group.

36. The method of claim 19, wherein one or more of the parameters describing the category of media files is provided by a plurality of actions, the plurality of action including clicking on an icon on a website, placing a phone call, sending an e-mail, and sending a text message.
